(19) United States
(12) Patent Application Publication
(10) Pub. No.: US 2020/0124924 A1
(43) Pub. Date: Apr. 23, 2020

(54) ARRAY SUBSTRATE, DISPLAY PANEL AND DISPLAY DEVICE

(71) Applicant: HKC Corporation Limited, Shenzhen (CN)

(72) Inventor: Jianfeng Shan, Shenzhen (CN)

(21) Appl. No.: 16/243,025

(22) Filed: Jan. 8, 2019

Related U.S. Application Data
(63) Continuation of application No. PCT/CN2018/114625, filed on Nov. 8, 2018.

(30) Foreign Application Priority Data
Oct. 23, 2018 (CN) 201811239077.9

(51) Int. Cl. G02F 1/1343; G02F 1/1362

(52) U.S. Cl. CPC G02F 1/134309; G02F 1/136286; G02F 1/1368; G02F 2001/134318; G02F 1/13439

(57) ABSTRACT

The present application discloses an array substrate, a display panel and a display device, wherein the array substrate comprises a plurality of scan lines and data lines, a plurality of pixel structures and a common electrode line connecting the respective pixel structures; and the common electrode line includes two connection sections and two electrode sections connected in parallel with each other.

### CROSS REFERENCE TO RELATED APPLICATIONS

The present application is a Continuation Application of PCT Application No. PCT/CN2018/114625 filed on Nov. 8, 2018, which claims the benefit of Chinese Patent Application No. 201811239077.9 filed on Oct. 23, 2018. All the above are hereby incorporated by reference.

### FIELD OF THE DISCLOSURE

The present application relates to the technical field of display products, in particular, to an array substrate, a display panel, and a display device.

### BACKGROUND OF THE DISCLOSURE

At present, the pixel design of the display device generally designs a common electrode (COM) line on the array substrate side to be connected between the pixels, however, in the mass production process, some COMs may be disconnected, which differentiates the resistance of the COM after the disconnection while the line defect phenomenon causing a decrease in the yield when the screen is displayed. The currently widely used remedy is to rewire the line at the wire break by laser chemical vapor deposition (Laser CVD), however, this method is cumbersome and inconvenient to operate, which prolongs the production time of the display device.

### SUMMARY OF THE DISCLOSURE

### Technical Problems

The main purpose of the present application is to provide an array substrate, which aims to solve the technical problem that the common electrode line in the exemplary technique is repaired by Laser CVD once the line is broken, which prolongs the production time of the display device.

### Technical Solutions

The array substrate provided by the present application, comprising:

a plurality of scan lines and a plurality of data lines;

a pixel structure arranged in an array;

a common electrode line connecting the respective pixel structures, the common electrode line including a first connecting segment and a second connection section between two adjacent pixel structures and connected in parallel with each other, and a first electrode section and a second electrode section located in any pixel structures and connected in parallel with each other.

Optionally, the common electrode line further includes two shading sections located in any pixel structures, and the two shading sections are respectively disposed on two sides of the pixel electrodes of the pixel structures;

each of the shading sections is respectively connected with the first connection section, the second connection section, and the first electrode section and the second electrode section at a predetermined angle.

Optionally, the shading sections are disposed in a vertical direction, and the first connection section, the second connection section, and the first electrode section and the second electrode section are all disposed in a lateral direction.

Optionally, the first connection section is disposed in line with the first electrode section, and the second connection section is disposed in line with the second electrode section.

Optionally, the first connection section and the first electrode section are both made of the same metal material; and/or

the second connection section and the second electrode section are both made of the same metal material.

Optionally, the first connection section and the first electrode section are both connected to a middle portion of the shading section, and the second connection section and the second electrode section are connected with a vertical end of the shading section.

Optionally, the common electrode line further includes a third connection section connected in parallel with the first connection section and the second connection section, and a third electrode section connected in parallel with the first electrode section and the second electrode section;

the third connection section is disposed in line with the third electrode section, and is connected with the end of the shading section away from the second connection section and the second electrode section in a vertical direction.

Optionally, the common electrode line is disposed in the same layer as the scan line.

Optionally, the common electrode line is disposed in the same layer as the data line.

Optionally, the shading sections are disposed in a lateral direction, and the first connection section, the second connection section, and the first electrode section and the second electrode section are all disposed in a vertical direction.

The present application further provides a display panel, wherein the display panel comprises an array substrate, the array substrate including:

a plurality of scanning lines arranged along the lateral direction and a plurality of data lines arranged along the vertical interval;

a plurality of pixel electrodes respectively disposed in respective grids separated by the scan lines and the data lines; and

a common electrode line disposed corresponding to each of the pixel electrodes; the common electrode line including a first connecting segment and a second connection section between two adjacent pixel electrodes and connected in parallel with each other, and a first electrode section and a second electrode section located in any pixel electrodes and connected in parallel with each other.

The present application further provides a display device, wherein the display device comprises a display panel, the display panel including an array substrate, the array substrate including:

a plurality of pixel units including a first pixel unit and a second pixel unit arranged adjacent in a vertical direction, the first pixel unit including a first sub-pixel, the second pixel unit including a second sub-pixel corresponding to the first sub-pixel; wherein,

the first sub-pixel includes a first four-domain region and a second four-domain region arranged in a vertical direction, and the second four-domain region is disposed adjacent to the second sub-pixel with respect to the first four-domain region;

the first four-domain region has a transmittance lower than the second four-domain region, and an area ratio of the second four-domain region to the third four-domain region is less than or equal to 4/6 and greater than or equal to 3/7.

Optionally, the common electrode line further includes two shading sections located in any pixel structures, and the two shading sections are respectively disposed on two sides of the pixel electrodes of the pixel structures;

each of the shading sections is respectively connected with the first connection section, the second connection section, and the first electrode section and the second electrode section at a predetermined angle.

Optionally, the shading sections are disposed in a vertical direction, and the first connection section, the second connection section, and the first electrode section and the second electrode section are all disposed in a lateral direction.

Optionally, the first connection section is disposed in line with the first electrode section, and the second connection section is disposed in line with the second electrode section.

Optionally, the first connection section and the first electrode section are both connected to a middle portion of the shading section, and the second connection section and the second electrode section are connected with a vertical end of the shading section.

Optionally, the common electrode line further includes a third connection section connected in parallel with the first connection section and the second connection section, and a third electrode section connected in parallel with the first electrode section and the second electrode section;

the third connection section is disposed in line with the third electrode section, and is connected with the end of the shading section away from the second connection section and the second electrode section in a vertical direction.

Optionally, the common electrode line is disposed in the same layer as the scan line.

Optionally, the common electrode line is disposed in the same layer as the data line.

Optionally, the shading sections are disposed in a lateral direction, and the first connection section, the second connection section, and the first electrode section and the second electrode section are all disposed in a vertical direction.

The technical solution of the present application is to configure the connection portion and the electrode portion of the common electrode line of the array substrate as a plurality of sections connected in parallel, thereby improving the fault tolerance of the disconnection on the common electrode line. In other words, when any branches of the connection portion or the electrode portion on the common electrode line are disconnected, the current may still be transmitted through other branches connected in parallel at the broken line, thereby avoiding the case that in the exemplary technique, once the common electrode line is broken, the Laser CVD repair must be performed on the disconnection immediately, so that the production time of the liquid crystal display panel is prolonged. Therefore, the reliability and efficiency of the production of the liquid crystal display panel are effectively improved.

### BRIEF DESCRIPTION OF THE DRAWINGS

In order to illustrate the technical schemes in the embodiments of the present application or in the prior art more clearly, the drawings which are required to be used in the description of the embodiments or the prior art are briefly described below. It is obvious that the drawings described below are only some embodiments of the present application. It is apparent to those of ordinary skill in the art that other drawings may be obtained based on the structures shown in accompanying drawings without inventive effort.

FIG. 1 is a normal structural view of a first embodiment of an array substrate of the present application;

FIG. 2 is a structural view showing a disconnection of a common electrode line of the array substrate of FIG. 1;

FIG. 3 is a normal structural view of a second embodiment of an array substrate of the present application;

FIG. 4 is a normal structural view of a third embodiment of an array substrate of the present application.

### DESCRIPTION OF THE REFERENCE NUMERALS

| Reference | | Reference | |
|---|---|---|---|
| Numeral | Name | Numeral | Name |
| 1 | Scan line | 2 | Data line |
| 3 | Pixel electrode | 4 | Common electrode |
| | | | line |
| 41 | First connection section | 42 | Second connection |
| | | | section |
| 43 | Third connection section | 44 | First electrode section |
| 45 | Second electrode section | 46 | Third electrode section |
| 47 | Shading section | 5 | Thin-film transistor |

With reference to the drawings, the implement of the object, features and advantages of the present application will be further illustrated in conjunction with embodiments.

### DETAILED DESCRIPTION OF THE EMBODIMENTS

The technical solutions in the embodiments of the present application will be clearly and completely described hereafter in connection with the embodiments of the present application. It is apparent that the described embodiments are just a part of the embodiments of the present application, but not the whole. Based on the embodiments of the present application, all the other embodiments obtained by that of ordinary skill in the art without inventive effort are within the scope of the present application.

It should be noted that if the embodiments of the present application relates to directional indications (such as up, down, left, right, front, back, . . . ), they are only used to explain the relative positional relationship, motion situation and the like between components in a certain posture (as shown in the drawings), if the specific posture changes, the directional indication shall also change accordingly.

In addition, if the embodiments of the present application relates to the descriptions of “first”, “second” and the like, they are only used for the purpose of description only, and are not to be construed as indicating or implying their relative importance or implicitly indicating the number of technical features indicated. Thus, features defined with “first”, “second” may include at least one such feature, either explicitly or implicitly. In addition, the technical solutions between the various embodiments may be combined with each other, provided that those skilled in the art can implement it, and when the combination of the technical solutions is contradictory or impossible to implement, it should be considered that the combination of these technical solutions does not exist, nor is it within the scope of protection required by this application.

The present application provides an array substrate and a display panel having the array substrate. In the present embodiment, the display panel is a liquid crystal display panel. It is understood that the liquid crystal display panel comprises a color film substrate and an array substrate disposed at a relatively spaced interval, and a liquid crystal filled between the two substrates. The liquid crystal is located in a liquid crystal box in which the array substrate and the color film substrate are stacked. Without loss of generality, the liquid crystal display panel may be applied to a liquid crystal television, a liquid crystal display, etc., and the design is not limited thereto.

For a TFT-LCD, its driver circuit generally contains necessary components such as a scan line, a data line, a thin film transistor, and a common electrode line. It is understood that the pixel structure is formed on the substrate, wherein the pixel structure is an area formed by interlacing two adjacent data lines, scan lines, and common electrode lines (COM), and wherein the data line is used to transmit a signal corresponding to the pixel, the scan line is used to transmit the scan signal, and the common electrode line is used to provide a common voltage for the pixel.

However, in the mass production process, parts of COM may be disconnected. The currently widely used remedy is to rewire the line at the wire break by Laser CVD, however, this method is cumbersome and inconvenient to operate, which prolongs the production time of the display device. Therefore, the present application has made related improvements to the array substrate for this problem:

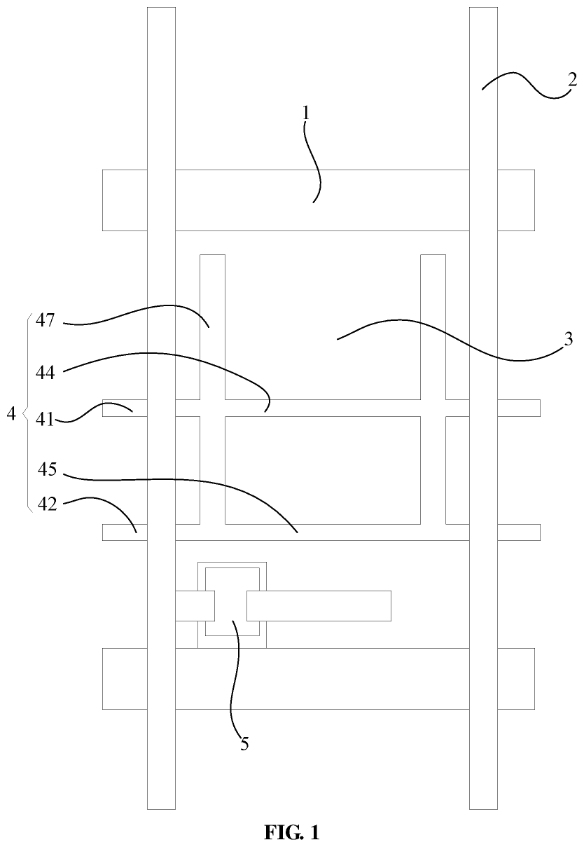

in the embodiments of the present application, referring to FIGS. 1 to 4, the array substrate comprises:

a plurality of scanning lines 1 arranged along the lateral direction and a plurality of data lines 2 arranged along the vertical interval;

a plurality of pixel structures formed in respective grids separated by the scan lines 1 and the data lines 2; and

a common electrode line 4 connecting the respective pixel structures; the common electrode line 4 including a first connecting segment 41 and a second connection section 42 between two adjacent pixel structures and connected in parallel with each other, and a first electrode section 44 and a second electrode section 45 located in any pixel structures and connected in parallel with each other.

It is understood that the common electrode line 4 connects each pixel structure, that is, the common electrode line 4 is overlapped with the pixel electrode 3 of each pixel structure to form a capacitor. In fact, only the first electrode section 44 and the second electrode section of the common electrode line 4 are overlapped with the pixel electrode 3 to form a capacitor, while the first connection section 41 and the second connection section 42 of the common electrode line 4 are portions spanning between adjacent pixel electrodes 3, which are configured to connect the first electrode section 44 and the second electrode section 45 corresponding to the adjacent pixel electrodes 3.

It is easily understood that by configuring the connection portion and the electrode portion of the common electrode line 4 as two sections in parallel, so that when a disconnection occurs in any line section of the connection portion and the electrode portion, the current may be continuously transmitted through the other branch in parallel with the disconnection without an immediate repair by Laser CVD on the broken position, which otherwise prolongs the production time of the liquid crystal display panel. It should be noted that it is a technical concept of the present application as long as the connection portion and the electrode portion of the common electrode line 4 are disposed in parallel. That is, the common electrode line 4 is not limited to only including the first connection section 41, the second connection section 42 connected in parallel with each other, and the first electrode section 44 and the second electrode section 45 connected in parallel with each other, in order to avoid the case that the first connection section 41 and the second connection section 42 (or the first electrode section 44 and the second electrode section 45) are so damaged simultaneously that the common electrode wire 4 is required to repair. The common electrode line 4 of the present application may further include more connection sections in parallel with the first connection section 41 and the second connection section 42, and more electrode sections in parallel with the first electrode section 44 and the second electrode section 45, thereby minimizing the probability of the common electrode wire 4 being truly broken.

The technical solution of the present application is to configure the connection portion and the electrode portion of the common electrode line 4 of the array substrate as a plurality of sections connected in parallel, thereby improving the fault tolerance of the disconnection on the common electrode line 4. In other words, when any branches of the connection portion or the electrode portion on the common electrode line 4 are disconnected, the current may still be transmitted through other branches connected in parallel at the broken line, thereby avoiding the case that in the exemplary technique, once the common electrode line 4 is broken, the Laser CVD repair must be performed on the disconnection immediately, so that the production time of the liquid crystal display panel is prolonged. Therefore, the reliability and efficiency of the production of the liquid crystal display panel are effectively improved.

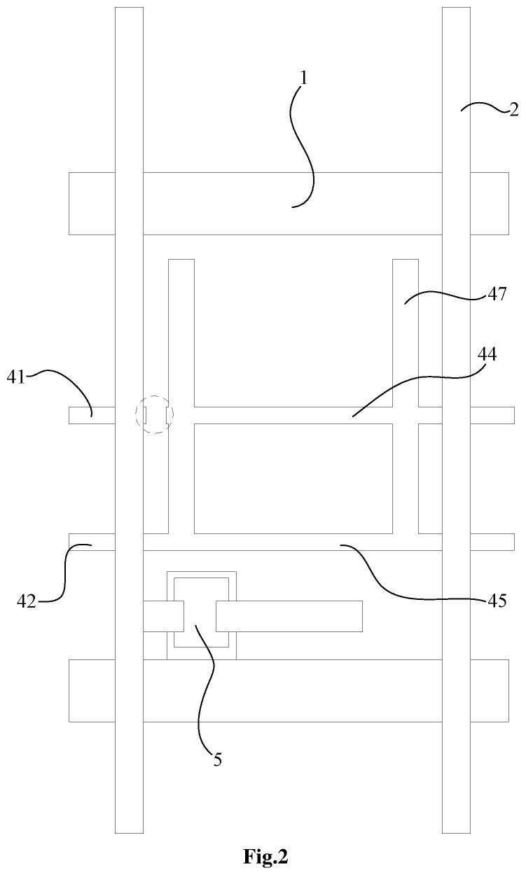

Further, referring FIGS. 1 and 2, the common electrode line 4 further includes two shading sections 47 located in any pixel structures, and the two shading sections 47 are respectively disposed on two sides of the pixel electrodes 3; each of the shading sections 47 is respectively connected with the first connection section 41, the second connection section 42, and the first electrode section 44 and the second electrode section 45 at a predetermined angle. It is understood that the shading section 47 is disposed in the same layer as the common electrode line 4, and is also configured to form a capacitor with the pixel electrode 3. The first electrode section 44 and the second electrode section 45 are connected between the two shading sections 47 of the same pixel structure, and the first connection section 41 and the second connection section 42 are connected between the two shading sections 47 between adjacent pixel structures. It should be noted that, as long as the first connection section 41, the second connection section 42, the first electrode section 44, and the second electrode section 45 are electrically connected with the shading section 47, and do not interfere with other structures on the array substrate, the size of the angle between the first connection section 41, the second connection section 42, the first electrode section 44, and the second electrode section 45 and the shading section 47 is not limited by the present application.

In the first embodiment of the present application, the shading sections 47 are disposed in a vertical direction, and the first connection section 41, the second connection section 42, and the first electrode section 44 and the second electrode section 45 are all disposed in a lateral direction. It is understood that this arrangement is favorable for adapting the conventional rectangular design of the pixel electrode 3 (the lateral direction the width, the vertical direction is the length), thereby reducing the design difficulty of the entire array substrate, and other structures are disposed in which the array is substantially flush with the lateral direction of the pixel electrode 3, thus, the routing of the electrode line 4 may be easily shared and prevented from being wound. In particular, the common electrode line 4 is disposed in the same layer as the scan line 1. First, since a pixel structure is planned between any two scan lines 1, there is no conflict with the scan line 1 inevitably if the common electrode line 4 is to overlap with the pixel electrode 3. In addition, the common electrode line 4 and the scan line 1 are prepared by using the same metal layer, which is also advantageous for reducing the production difficulty of the array substrate and improving the production efficiency thereof. It should be noted that the present design is not limited thereto. In other embodiments, the common electrode line 4 may also be disposed in the same layer as other metal layers.

Further, the first connection section 41 is disposed in line with the first electrode section 44, and the second connection section 42 is disposed in line with the second electrode section 45. It is understood that, in this way, the first connection section 41 and the first electrode section 44 may be made of the same straight metal line, and the second connection section 42 and the second electrode section 45 may also be made of the same straight metal line, which is advantageous for reducing the processing difficulty of the common electrode line 4, thereby reducing the processing difficulty of the entire array substrate and improving the production efficiency of the liquid crystal display panel. It should be noted that the present design is not limited thereto. In other embodiments, the first connection section 41 and the first electrode section 44 may also be disposed in parallel or at an angle to each other, and similarly, the second connection section 42 and the second electrode section 45 may also be disposed in parallel or at an angle to each other.

Further, the first connection section 41 and the first electrode section 44 are both connected to a middle portion of the shading section 47, and the second connection section 42 and the second electrode section 45 are connected with a vertical end of the shading section 47. It is understood that the first connection section 41 and the second connection section 42, the first electrode section 44 and the second electrode section 45 are kept at a large interval to avoid mutual influence between the two, thereby improving the reliability of the current transmission of the common electrode line 4.

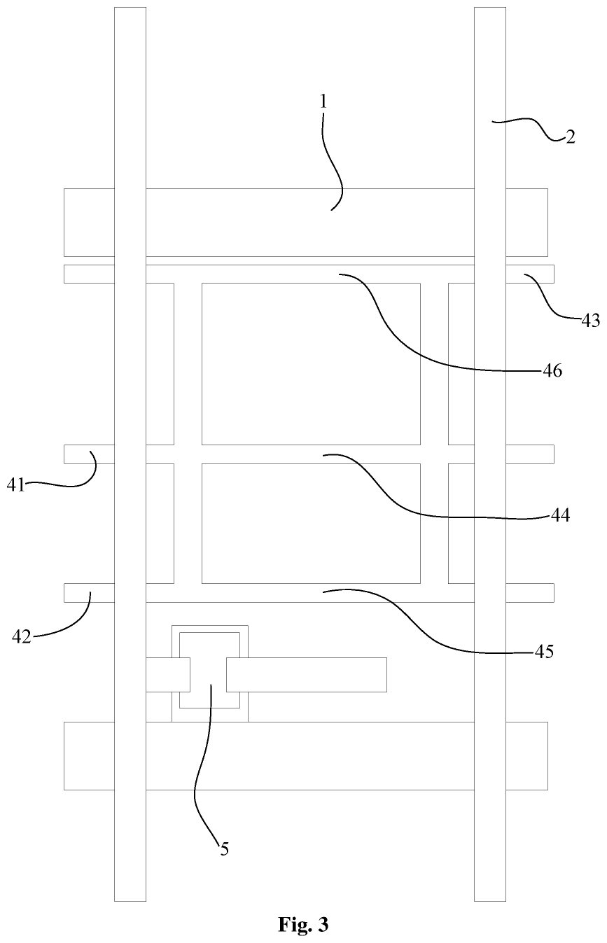

In particular, referring to FIG. 3, in the second embodiment of the present application, based on the first embodiment, the common electrode line 4 further includes a third connection section 43 connected in parallel with the first connection section 41 and the second connection section 42, and a third electrode section 46 connected in parallel with the first electrode section 44 and the second electrode section 45; the third connection section 43 is disposed in line with the third electrode section 46, and is connected with the end of the shading section 47 away from the second connection section 42 and the second electrode section 45 in a vertical direction. In this way, the electrical connection function by the extension length of the shading section 47 is utilized fully. It should be noted that the present design is not limited thereto. In other embodiments, specifically, the first connection section 41 and the first electrode section 44 may also be connected with other positions of the shading section 47, and similarly, the second connection section 42 and the second electrode section 45 may also be connected with other positions of the shading section 47.

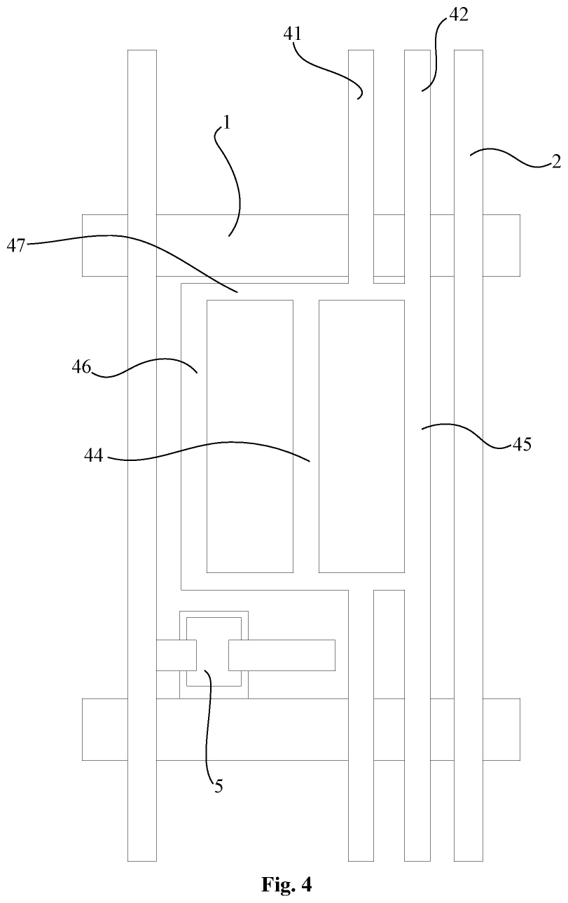

In the third embodiment of the present application, referring to FIG. 4, the shading section 47 is disposed in a lateral direction, and the first connection section 41, the second connection section 42, and the first electrode section 44 and the second electrode section 45 are all disposed in a vertical direction. In particular, the common electrode line 4 is disposed in the same layer as the data line 2. Since a pixel structure is planned between any two data lines 2, there is no conflict with the data line 2 inevitably if the common electrode line 4 is to overlap with the pixel electrode 3. Therefore, in this way, the routing of the common electrode line 4 may be facilitated to some extent to avoid the winding.

Further, in the present embodiment, in order to increase the fault tolerance of disconnection for the electrode portion of the common electrode line 4, the common electrode line 4 includes, in addition to the first electrode section 44 and the second electrode section 45, a third electrode section 46. However, since a thin film transistor 5 is further disposed between the two data lines 2 in a vertical direction, the common electrode line 4 includes only the first connection section 41 and the second connection section 42 in order to prevent the connection portion of the common electrode line 4 from interfering with the thin film transistor 5.

The present application further provides a display device, which comprises a display panel including an array substrate. The specific structure of the array substrate refers to the above embodiments. Since all the technical solutions of the foregoing embodiments are used in the display device, at least the technical effects brought by the technical solutions of the foregoing embodiments are included and are not described herein.

The above mentioned is only the preferred embodiment of the present application, which does not limit the patent scope of the present invention, and any equivalent structure transformation made by using the specification and the drawings of the present invention or direct/indirect applications in other related technical fields should be contained in the scope of patent protection in a similar way.

What is claimed is:

1. An array substrate, wherein the array substrate comprises:
a plurality of scan lines and a plurality of data lines;
a pixel structure arranged in an array;
a common electrode line connecting the respective pixel structures, the common electrode line including a first connecting segment and a second connection section between two adjacent pixel structures and connected in parallel with each other, and a first electrode section and a second electrode section located in any pixel structures and connected in parallel with each other.

2. The array substrate according to claim 1, wherein the common electrode line further includes two shading sections located in any pixel structures, and the two shading sections are respectively disposed on two sides of the pixel electrodes of the pixel structures;
each of the shading sections is respectively connected with the first connection section, the second connection section, and the first electrode section and the second electrode section at a predetermined angle.

3. The array substrate according to claim 2, wherein the shading sections are disposed in a vertical direction, and the first connection section, the second connection section, and the first electrode section and the second electrode section are all disposed in a lateral direction.

4. The array substrate according to claim 3, wherein the first connection section is disposed in line with the first electrode section, and the second connection section is disposed in line with the second electrode section.

5. The array substrate according to claim 4, wherein the first connection section and the first electrode section are both made of the same metal material; and/or
the second connection section and the second electrode section are both made of the same metal material.

6. The array substrate according to claim 4, wherein the first connection section and the first electrode section are both connected to a middle portion of the shading section, and the second connection section and the second electrode section are connected with a vertical end of the shading section.

7. The array substrate according to claim 6, wherein the common electrode line further includes a third connection section connected in parallel with the first connection section and the second connection section, and a third electrode section connected in parallel with the first electrode section and the second electrode section;
the third connection section is disposed in line with the third electrode section, and is connected with the end of the shading section away from the second connection section and the second electrode section in a vertical direction.

8. The array substrate of claim 3, wherein the common electrode line is disposed in the same layer as the scan line.

9. The array substrate of claim 3, wherein the common electrode line is disposed in the same layer as the data line.

10. The array substrate according to claim 2, wherein the shading sections are disposed in a lateral direction, and the first connection section, the second connection section, and the first electrode section and the second electrode section are all disposed in a vertical direction.

11. A display panel, wherein the display panel comprises an array substrate, the array substrate including:
a plurality of scan lines and a plurality of data lines;
a pixel structure arranged in an array;
a common electrode line connecting the respective pixel structures, the common electrode line including a first connecting segment and a second connection section between two adjacent pixel structures and connected in parallel with each other, and a first electrode section and a second electrode section located in any pixel structures and connected in parallel with each other.

12. A display device, wherein the display device comprises a display panel, the display panel including an array substrate, the array substrate including:
a plurality of scan lines and a plurality of data lines;
a pixel structure arranged in an array;
a common electrode line connecting the respective pixel structures, the common electrode line including a first connecting segment and a second connection section between two adjacent pixel structures and connected in parallel with each other, and a first electrode section and a second electrode section located in any pixel structures and connected in parallel with each other.

13. The display device according to claim 12, wherein the common electrode line further includes two shading sections located in any pixel structures, and the two shading sections are respectively disposed on two sides of the pixel electrodes of the pixel structures;
each of the shading sections is respectively connected with the first connection section, the second connection section, and the first electrode section and the second electrode section at a predetermined angle.

14. The display device according to claim 13, wherein the shading sections are disposed in a vertical direction, and the first connection section, the second connection section, and the first electrode section and the second electrode section are all disposed in a lateral direction.

15. The display device according to claim 14, wherein the first connection section is disposed in line with the first electrode section, and the second connection section is disposed in line with the second electrode section.

16. The display device according to claim 15, wherein the first connection section and the first electrode section are both connected to a middle portion of the shading section, and the second connection section and the second electrode section are connected with a vertical end of the shading section.

17. The display device according to claim 16, wherein the common electrode line further includes a third connection section connected in parallel with the first connection section and the second connection section, and a third electrode section connected in parallel with the first electrode section and the second electrode section;
the third connection section is disposed in line with the third electrode section, and is connected with the end of the shading section away from the second connection section and the second electrode section in a vertical direction.

18. The display device of claim 14, wherein the common electrode line is disposed in the same layer as the scan line.

19. The display device of claim 14, wherein the common electrode line is disposed in the same layer as the data line.

20. The display device according to claim 13, wherein the shading sections are disposed in a lateral direction, and the first connection section, the second connection section, and the first electrode section and the second electrode section are all disposed in a vertical direction.
